(19) United States
(12) Patent Application Publication
(10) Pub. No.: US 2015/0032283 A1
(43) Pub. Date: Jan. 29, 2015

(54) DATA CENTER COOLING

(71) Applicant: INTERNATIONAL BUSINESS MACHINES CORPORATION, Armonk, NY (US)

(72) Inventors: BHOOSHAN P. KELKAR, PUNE (IN); SANDEEP R. PATIL, PUNE (IN)

(21) Appl. No.: 13/952,752

(22) Filed: Jul. 29, 2013

(51) Int. Cl. G05D 23/19

(52) U.S. Cl. CPC G05D 23/19
USPC 700/300

(57) ABSTRACT

Embodiments of the invention provide techniques of monitoring and controlling temperature in a data center having a plurality of systems. Operating parameters of one or more cooling devices in the data center may be dynamically adjusted based on characteristics of the data center. An associated method may include monitoring in real time temperature and data flow patterns with respect to the systems in a zone of the data center, computing an optimal temperature based on the real time data and historical data collected in a repository, and activating one or more cooling devices in the zone upon determining that the temperature in the zone exceeds a predefined threshold.

### BACKGROUND

The various embodiments of the invention described herein generally relate to cooling a data center and more specifically relate to monitoring and controlling temperature in a data center.

Recently businesses have grown increasingly dependent on the processing power of computer systems. As the size and complex nature of a business grows, computing needs increase. Large businesses require sophisticated computer systems, such as servers and storage devices, to provide for their computing needs. Such computer systems often require fast and continuous operation as well as communication capabilities.

A variety of such computer systems may be housed in a common facility known as a data center. Data centers also may house associated computer components such as telecommunication systems and storage systems. Further, redundant and backup units such as power supplies, data communication connections, and environmental and security devices also may be housed in data centers. Because of cost concerns, data centers are designed to house a relatively large number of computer systems and their associated components in a relatively tight foot print. Locating a large number of heat generating systems and components in close proximity to one another requires that heat dissipation issues be addressed.

At the same time, the industry trend has been to continuously increase the number of electronic components inside each computer system to provide maximum processing power. Such trend exacerbates heat dissipation issues, which may compromise the structural and data integrity of data centers.

A variety of cooling mechanisms are used to dissipate heat generated by computer systems in data centers. The cooling mechanisms typically are used to ensure that data center computer systems operate within a safe temperature range. However, such cooling mechanisms substantially impact electric power consumption of data centers, and consequently they may be costly.

### BRIEF SUMMARY

The various embodiments of the invention described herein provide techniques of monitoring and controlling temperature in a data center. The data center may include a plurality of zones. The various embodiments may include a system/device, a computer program product, and a method for monitoring and controlling temperature in a data center including a plurality of zones and a plurality of systems. The data center may be located in a computing cloud or a grid.

A method according to the various embodiments may include receiving real time data from one or more monitoring devices in a zone among a plurality of zones of a data center at a central control located within the zone. The real time data may include temperature and data flow patterns, and the central control may include one or more processors. The method further may include collating the real time data from each of the one or more monitoring devices at the central control. The method further may include activating one or more cooling components in the zone upon determining that the temperature in the zone exceeds a predefined threshold, thereby maintaining the temperature in the zone at an optimal temperature.

In one embodiment, the method further may include transmitting the collated real time data from the central control to a master control subsequent to collating the data in real time. In a further embodiment, at least one of the central control or the master control may determine from the real time data whether the temperature in the zone exceeds the predefined threshold. In a further embodiment, at least one of the central control or the master control may compute the optimal temperature based on the real time data and historical data stored in a repository. In a further embodiment, the one or more monitoring devices may include at least one of a temperature sensor, a camera, an RFID tag, an acoustic sensor, a visual sensor, a semiconducting device, or a thermocouple. In a further embodiment, the real time data further may include heat generation or heat dissipation patterns. In a further embodiment, the temperature and data flow pattern may be monitored in real time and may be collated in real time for the zone. In a further embodiment, at least one of the central control or the master control may activate cooling components in the zone. In a further embodiment, at least one of the central control or the master control may activate one or more cooling components in a region surrounding a monitoring device among the one or more monitoring devices. In a further embodiment, the central control or the master control may include at least one of an integrated circuit processor or a computing system.

A further method according to the various embodiments may include receiving real time data form one or more monitoring devices in a zone among a plurality of zones of a data center at a master control. The real time data may include temperature and data flow patterns. The master control may include one or more processors. The method further may include determining from the real time data whether the temperature a region surrounding a monitoring device among the one or more monitoring devices exceeds a predefined threshold. The method further may include activating one or more cooling components in the region surrounding the monitoring device upon determining that the temperature in the region surrounding the monitoring device exceeds the predefined threshold, thereby maintaining the temperature in the region surrounding the monitoring device at an optimally determined temperature.

In one embodiment of the method, the master control may collate the real time data received from each of the one or more monitoring devices at the master control. In a further embodiment, the master control may compute the optimal temperature based on the real time data received from at least one of the one or more monitoring devices and historical data stored in a repository. In a further embodiment, the one or more monitoring devices may include at least one of a temperature sensor, a camera, an RFID tag, an acoustic sensor, a visual sensor, a semiconducting device, or a thermocouple. In a further embodiment, the real time data further may include heat generation or heat dissipation patterns. In a further embodiment, the master control may activate one or more cooling components in the zone. In a further embodiment, the master control may activate the one or more cooling components in the region surrounding the monitoring device. In a further embodiment, the master control may include at least one of an integrated circuit processor or a computing system.

A device according to the various embodiments may include at least one processor that may be configured to perform one or more steps of one or both of the above recited methods. A system according to the various embodiments may include a processor and a memory storing a program, which, when executed on the processor, may perform one or more steps of one or both of the above recited methods.

Furthermore, a method according to the various embodiments may include identifying, by operation of one or more processors, one or more datasets within the data center having high access potential. The method further may include identifying one or more datasets having historical heat generation or temperature parameters that exceed a predefined first threshold. The method further may include identifying one or more zones among the plurality of zones that include the identified one or more datasets having high access potential and the identified one or more datasets having historical heat generation or temperature parameters that exceed the predefined first threshold. The method further may include monitoring real time temperature throughout the identified one or more zones of the data center to determine which of the identified one or more zones has an average temperature exceeding a predefined second threshold. Upon determining that at least one zone among the identified one or more zones has an average temperature that exceeds the predefined second threshold, the method further may include adjusting operating parameters of one or more cooling devices within the at least one zone.

In one embodiment, the method step of identifying the one or more datasets having high access potential may include utilizing at least one of predictive heuristic analysis and an Information Lifecycle Management (ILM) policy. In a further embodiment, the method step of identifying the one or more datasets having high access potential may include utilizing stored dataset access pattern data. In a further embodiment, the method step of identifying the one or more datasets having historical heat generation or temperature parameters that exceed a predefined first threshold may include utilizing stored dataset temperature and heat generation pattern data.

In a further embodiment, the method step of monitoring real time temperature throughout the identified one or more zones may include receiving collated temperature or heat generation data from one or more monitoring devices within each zone via a central control associated with each zone. In an alternative embodiment, the method step of monitoring real time temperature throughout the identified one or more zones of the data center may include receiving temperature or heat generation data directly from one or more monitoring devices within each zone. In a further embodiment, the method step of adjusting the operating parameters of the one or more cooling devices within the at least one zone may include increasing the output of the one or more cooling devices such that the average temperature within each of the at least one zone is decreased to a predefined amount below the predefined second threshold.

An additional embodiment includes a computer-readable storage medium storing an application, which, when executed on a processor, may perform one or more steps of the method recited immediately above. A further embodiment includes a system having a processor and a memory storing a program, which, when executed on the processor, may perform one or more steps of the method recited immediately above. A further embodiment includes a device that may include a processor configured to perform one of more steps of the method recited immediately above.

### BRIEF DESCRIPTION OF THE DRAWINGS

So that the manner in which the above recited aspects are attained and can be understood in detail, a more particular description of embodiments, briefly summarized above, may be had by reference to the appended drawings.

Note, however, that the appended drawings illustrate only typical embodiments of this invention and are therefore not to be considered limiting of its scope, for the invention may admit to other equally effective embodiments.

FIG. 1 illustrates a block diagram of an exemplary computer network of data centers in which various embodiments of the invention may be implemented.

FIG. 2 illustrates a perspective view of a computer housing having a rack frame, according to one embodiment of the invention.

FIG. 3 illustrates a perspective view of a data center, according to one embodiment of the invention.

FIG. 4 illustrates a data center having a plurality of zones, according to one embodiment of the invention.

FIG. 5 illustrates a method of monitoring and controlling temperature in a data center, according to one embodiment of the invention.

FIG. 6 illustrates a further method of monitoring and controlling temperature in a data center, according to one embodiment of the invention.

FIG. 7 illustrates a block diagram of internal and external components of computing devices presented in FIG. 1, according to one embodiment of the invention.

### DETAILED DESCRIPTION

Embodiments of the present invention will now be described advantageously with reference to the aforementioned Figures. The size of computer systems generally continue to decrease, while the storage capacity and processing power of such computer systems generally continue to increase. Consequently, data centers generally have increased computational power and increased power density. Accordingly, data centers may have higher heat generation. Furthermore, data center cooling mechanisms consume power and may contribute to a further increase in power density. Existing cooling mechanisms rely on cooling appliances with a variety of cooling characteristics (e.g., variations in ratings, motor size, cooling efficiency, or power consumption). The power consumed by the cooling appliances is dependent upon their cooling characteristics. For example, a fan with 1 kW-0.4 rating consumes less power but generates less cool air, while a fan with 100 kW-0.93 rating consumes more power but also generates more cool air.

In one aspect, it is recognized that operating parameters of cooling devices within a data center may be dynamically adjusted by employing concepts of thermodynamics and heat transfer. More specifically, operating parameters of one or more cooling devices within a data center may be dynamically adjusted based on the data center environment, which may be defined by characteristics of the various cooling devices (i.e., cooling components) in the data center as well as an analysis of at least one of data access patterns, heat generation/dissipation patterns, and temperature within the data center.

Dynamic adjustment of operating parameters may lead to intelligent utilization of cooling devices to cool a plurality of computer systems hosting datasets in a data center, which may result in reduced power consumption. As further discussed herein, dynamic dataset analysis may involve identifying which datasets in the data center have high access potential—i.e., which datasets are likely to generate relatively more heat within the data center. To determine whether a dataset has high access potential, at least one of predictive heuristic analysis and an Information Lifecycle Management (ILM) policy may be utilized. Furthermore, stored dataset access pattern data may be utilized. Dynamic dataset analysis further may involve identifying which datasets in the data center have historical heat generation or temperature parameters that exceed a predefined first threshold. To determine whether a dataset has historical heat generation or temperature parameters that exceed such predefined first threshold, stored dataset temperature and heat generation pattern data may be utilized.

Furthermore, dynamic dataset analysis may involve identifying one or more zones of the data center that include the identified datasets having high access potential and the identified datasets having historical heat generation or temperature parameters that exceed the predefined first threshold. Additionally, dynamic dataset analysis may involve a master control of the data center monitoring real time temperature throughout the identified one or more zones of the data center to determine which of the identified one or more zones has an average temperature exceeding a predefined second threshold. Upon determining that at least one zone among the identified one or more zones has an average temperature that exceeds the predefined second threshold, the master control may adjust operating parameters of one or more cooling devices within the at least one zone. In an embodiment, the master control may increase the output of the one of more cooling devices such that the average temperature within each of the at least one zone is decreased to a predefined amount below the predefined second threshold.

Dynamically adjusting operating parameters of cooling devices based on characteristics of a data center may ensure that cooling devices are properly used to cool datasets (i.e., computer systems that host the datasets). For instance, such dynamic adjustment can ensure that highest rated cooling devices are properly used to cool datasets that correspond to a highest heat generation, and that lower rated cooling devices are properly used to cool datasets that cause comparatively less heat generation. Furthermore, such dynamic adjustment may reduce excessively hot or excessively cold regions in the data center and may preclude changing the data center environment (e.g., physically moving the computer systems or cooling devices) or preclude categorizing specific computer systems for specific types of data. Furthermore, dynamically adjusting operating parameters of cooling devices of the data center data center may reduce costs.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The various embodiments described herein may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g., an amount of storage space consumed by a user or a number of virtualized systems instantiated by the user). A user can access any of the resources that reside in the cloud at any time, and from anywhere across the Internet. In context of the various embodiments described herein, workloads of a data center may be deployed to a computing cloud (whether the cloud itself is provided by the enterprise or a third party). Moreover, cloud-based database systems, virtual machines, and a variety of other server applications may be used to manage such workloads.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As used herein, a data center may include any facility or portion of a facility in which computer operations are carried out. A data center may include servers dedicated to specific functions or serving multiple functions. Examples of computer operations include information processing, communications, simulations, and operational control. As used herein, a computer room may refer to a room of a building in which computer systems, such as rack-mounted servers, are operated. As used herein, a computer system may include any of various computer systems or components thereof. One example of a computer system is a rack-mounted server. As used herein, the term computer is not limited to those integrated circuits referred to in the art as a computer, but rather broadly refers to a processor, a server, a microcontroller, a microcomputer, a programmable logic controller (PLC), an application specific integrated circuit, and other programmable circuits.

As used herein, an entire dataset of a data center may include managed space (mapped storage) that relates to the totality of physical storage which is provided as logical storage to applications or operating systems and typically includes a sequence of one or more zones, each a grouping of one or more distinct storage media or partitions therein, such as independent drives, partitions, or RAID arrays, which are then aggregated to form contiguous logical storage for applications.

Typically data is stored in specialized physical data storage devices, though it may be maintained temporarily in random-access memory cache and ultimately on physical moving media, such as a conventional magnetic hard disk, optical disk, or similar electromechanical recording mechanism. A temporary random-access memory cache may be used to enhance operations by keeping frequently or recently accessed data in rapidly accessible memory. The same cache-like management techniques may be used to maintain update information between the time the update is received and when it is ultimately processed.

A Redundant Array of Independent Disks (RAID) is a storage arrangement of which there are many variations. Multiple drives are logically coupled to provide a larger composite storage entity that exhibits better storage capacity, performance and/or reliability than a single drive or a group of unrelated drives would provide. RAID is a standard term in the storage industry and its use here refers to the spectrum of capabilities unless otherwise stated. The RAID array(s), regardless of their actual configuration, provide composite storage areas. The various embodiments may utilize the storage provided by one or more RAID arrays, alone or in combination with other storage media.

A volume or logical volume, or logical region of storage, is typically made available to an operating system, through its volume mounting or similar mechanisms, or to a particular set of applications, such that the implementation of the dynamic reorganization is transparent to the operating system or applications that make use of the logical volume. A single logical volume is typically maintained in one or more zones, subject to the dynamic reorganization and related methods, which are dedicated to the needs of the particular volume or shared with other volumes, as determined by the particular embodiment or its configuration. The concept of volume is also present at a lower level, implemented by disk array technologies, such as RAID, that provide the physical zones in which actual data is stored. The lower level concept is usually referred to herein as physical storage or zones, which are ultimately referring to physical storage.

A data storage region may refer to a separately and independently accessible region of storage space. Multiple independent physical storage devices, or partitions therein, could each be designated as separate data storage regions, and multiple RAID arrays could each be designated as a data storage region. A data storage region is a configured storage space that is meaningful to the exemplary embodiments for dataset analysis purposes. It is desirable, though not essential, that no access to one data storage region should significantly interfere or limit concurrent access to other data storage regions. All data storage regions used as part of an entire dataset (managed space) may be required to have certain common properties determined by the particular embodiment.

A data storage region block is a single logical block of storage within a data storage region at the smallest addressable level. For purposes of the exemplary embodiments, each data storage region may have a set of sequentially numbered data storage region blocks. All blocks in a particular data storage region may be the same size, typically, but not necessarily, 512 to 4096 bytes and normally a power of 2.

There is a positive correlation between heat generation and temperature, and there is a negative correlation between heat dissipation and temperature. Hence, the terms “temperature”, “heat generation”, and “heat dissipation” should be considered in relation to one another throughout the various embodiments described herein.

Particular embodiments describe techniques for dynamically adjusting operating parameters within a data center. However, it should be understood that the techniques described herein may be adapted to a variety of purposes in addition to those specifically described herein. Accordingly, references to the specific embodiments are included to be illustrative and not limiting.

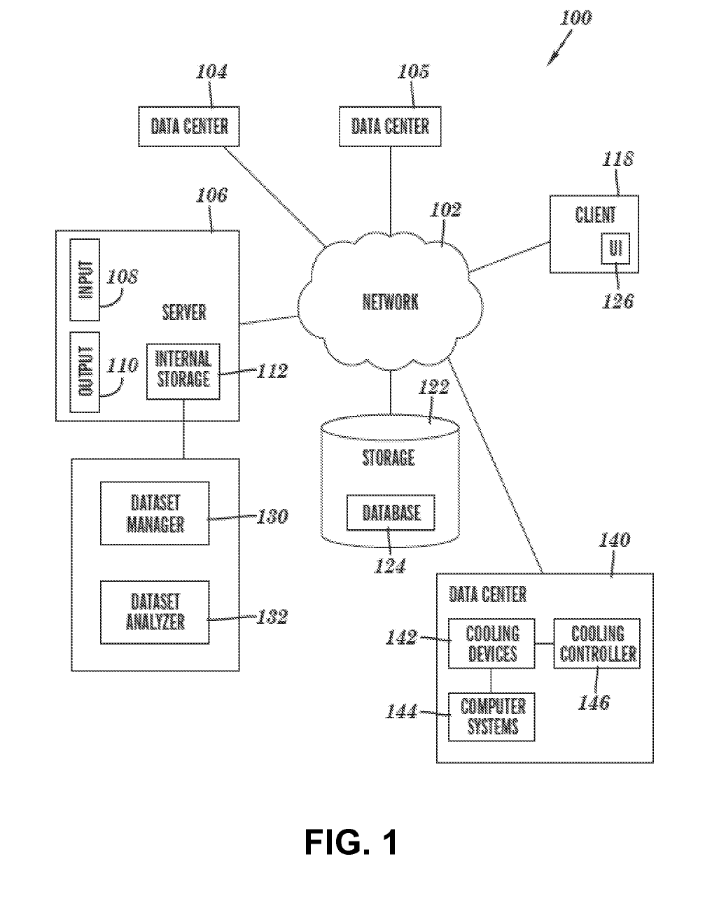

FIG. 1 is a conceptual block diagram of a sample computer networked environment 100 of data centers in which various embodiments of the invention may be implemented. FIG. 1 is an illustration of one implementation and is not intended to imply any limitation with regard to the environments in which different embodiments may be implemented. Modifications to the depicted environment may be made without departing from the scope of the various embodiments described herein.

Networked environment 100 may include a network 102. In one embodiment, network 102 may be the Internet, which uses the TCP/IP suite of protocols. Network 102 also may include a number of different types of networks, such as an intranet, a local area network (LAN), a wide area network (WAN), wireless local area network (WLAN), or synchronous optical network (SONET).

Network 102 may provide communication links between various devices, computers, and data centers. Network 102 may include connections, such as wireline or wireless communication links, fiber optic cables, or any other connection technology known in the art. Specifically, network 102 may include copper wires, optical fibers, wireless transmission, routers, firewalls, switches, gateway computers, and/or edge servers. Network 102 may include additional server computers, client computers, displays, and other devices not shown in FIG. 1.

Networked environment 100 may include data centers 104, 105, and 140. Data centers 104, 105, and 140 may be connected to client computer 118, server computer 106, and storage unit 122 via network 102. While three data centers 104, 105 and 140 are shown in FIG. 1, networked environment 100 may include fewer data centers or additional data centers according to alternative embodiments. In one embodiment, one or more of data centers 104, 105, and 140 may be located in a computing cloud or a grid.

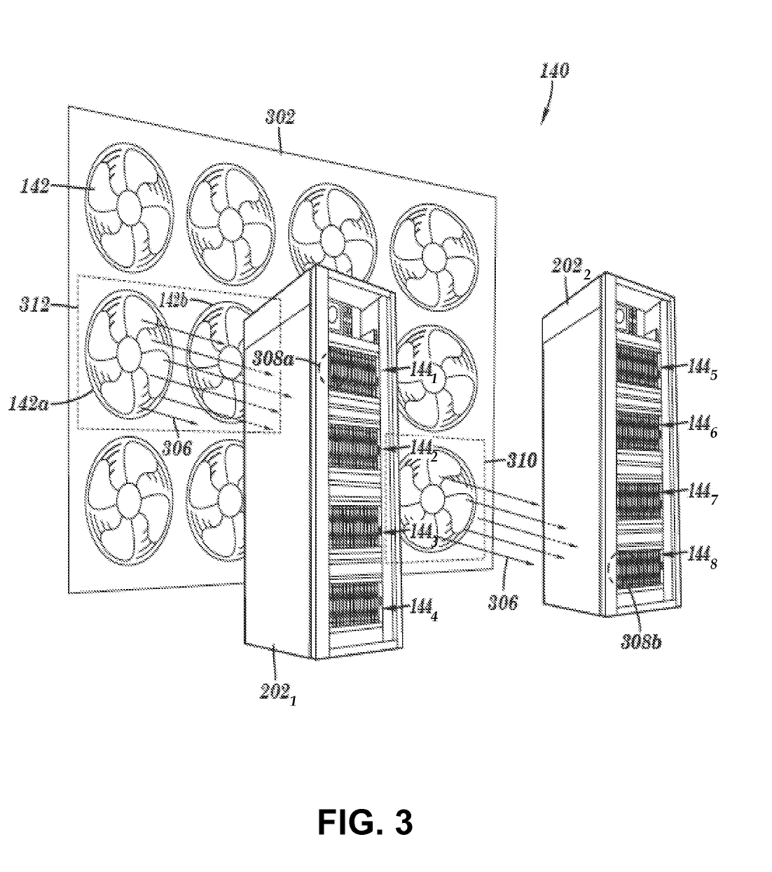

Data center 140 may include a plurality of computer systems 144, a plurality of cooling devices 142, and a cooling controller 146. Cooling devices 142 may be placed strategically throughout data center 140 so that cooling devices 142 cool the computer systems 144 (as shown in FIG. 3). In one embodiment, cooling controller 146 may be configured to monitor and control operating parameters of cooling devices 142. Cooling controller 146 also may maintain information about physical locations and cooling characteristics of cooling devices 142.

Server computer 106 may connect to network 102. Server computer 106 may include an input device 108 and an output device 110. Server computer 106 may be configured to communicate with data centers 104, 105, and 140, for example, via cooling controller 146 in data center 140. Server computer 106 may be a workstation, a mainframe computer, or a personal computer.

In one embodiment, server computer 106 may run dataset manager 130 and dataset analyzer 132. In such embodiment, server computer 106 may service requests by client computer 118 to dataset manager 130 and dataset analyzer 132. Dataset manager 130 may be configured to manage information relating to the location of datasets in the computer systems 144. Dataset manager 130 also may be configured to maintain associations between particular locations of datasets hosted by computer systems 144 and dedicated sets of cooling devices 142 responsible for cooling the computer systems 144. Dataset analyzer 132 may determine datasets having high access potential or having certain defined historical heat generation or temperature parameters. In one embodiment, dataset analyzer 132 may identify frequently accessed datasets, may determine power consumption/heat generation associated with accessed datasets, and accordingly may identify datasets having heat generation or temperature parameters exceeding a defined threshold. Dataset analyzer 132 also may be configured to determine computer systems that host the identified datasets.

In another embodiment, server computer 106 may run dataset analyzer 132, and client computer 118 may run dataset manager 130. In such embodiment, server computer 106 may respond to requests from dataset manager 130 to dataset analyzer 132.

Dataset manager 130, dataset analyzer 132, and cooling controller 146 may receive, generate, maintain, or transmit dataset information stored on one or more computer-readable storage devices, which may include internal storage 112 of server computer 106 or storage unit 122. Data processed by dataset manager 130, dataset analyzer 132, and cooling controller 146 may be stored in internal storage 112 of server computer 106 or in one or more databases 124 of storage unit 122.

Client computer 118 also may connect to network 102. Client computer 118 may be, for example, a mobile device, telephone, television receiver, cell phone, personal digital assistant, netbook, laptop computer, tablet computer, desktop computer, or any other type of computing device capable of executing software according to the embodiments described herein. Client computer 118 may include user interface (UI) 126. UI 126 may include, e.g., a graphical user interface (GUI) or a web user interface (WUI).

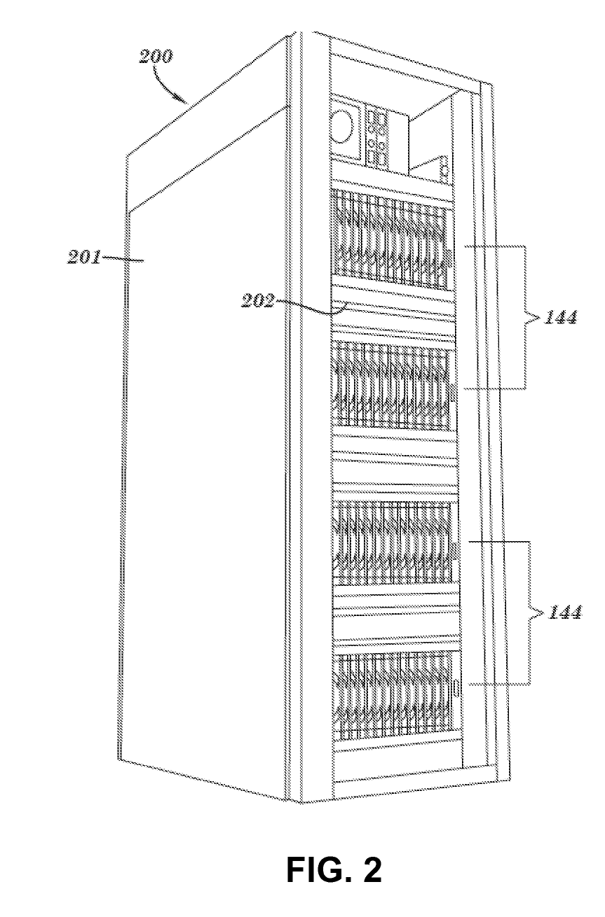

FIG. 2 illustrates a perspective view of a computer housing 200 having a computer rack 202. Computer rack 202 may have a cage-like structure. Housing 200 may incorporate full or partial doors/covers 201.

Computer rack 202 as shown in FIG. 2 may be construed to include any housing, frame, rack, compartment, blade server system or other structural arrangement, Such computer rack may incorporate doors/covers 201. In addition, computer rack 202 may be either a standalone computer processor or a sophisticated system, having high, mid or low end processing capability. Computer rack 202 may include a stack of computer systems 144, as well as supporting power supplies, networking equipment, and other similar and necessary components (not individually shown in FIG. 2). Computer systems 144 may include electronic system chasses or multi-blade center systems. Computer systems 144 may be disposed next to one another as tightly together as allowable by the design of computer rack 202 and the needs of the electronic components inside each of the computer systems 144.

FIG. 3 illustrates a simplified perspective view of data center 140. Other components may be added or existing components may be removed or modified without departing from the scope of the various embodiments described herein. For example, data center 140 may include any number of racks and various other devices known to be housed in data centers. Data center 140 may include one or more rows including one or more computer racks 202 (e.g., electronic cabinets). As shown in FIG. 3, data center 140 includes computer racks 202₁ and 202₂. Computer rack 202₁ includes computer systems 144₁, 144₂, 144₃, and 144₄. Computer rack 202₂ includes computer systems 144₅, 144₆, 144₇, and 144₈.

Computer racks 202 may be aligned in substantially parallel rows. Computer racks 202 may have open front sides such that computer systems 144 housed therein are visible. In an alternative embodiment, panels may cover the front sides of computer racks 202. Computer racks 202 may be configured to house a plurality of computer systems 144 designed to perform various operations, such as computing, switching, routing, or displaying. Computer systems 144 may include subsystems (not shown), such as high-speed video cards, memories, or semiconductor devices. Given such various operations and subsystems, computer systems 144 may generate relatively large amounts of heat. Because computer racks 202 may include numerous (e.g., 40 or more) computer systems 144 having multiple subsystems, computer racks 202 may transfer substantially large amounts of heat. Although the computer racks 202₁ and 202₂ are shown in FIG. 3 as including computer systems 144 throughout, generally computer racks 202 may include slots or areas that do not include computer systems 144.

Furthermore, data center 140 may include an array 302 of cooling devices 142. The array 302 of cooling devices 142 may produce and release cool air, for example at a regulated temperature, to cool computer systems 144 housed by computer racks 202 (i.e., cooling devices 142 may dissipate heat generated by computer systems 144). Cooling devices 142 may be configured to cool, vent, remove humidity, and/or provide air circulation to computer systems 144 of computer racks 202. In one embodiment, cooling devices 142 of array 302 may include fans arranged in a matrix form. Each cooling device 142 may be any electro-mechanical fan used for cooling computer systems 144 housed by computer racks 202. In further embodiments, cooling devices 142 may draw cool air from the outside of data center 140 or may expel warm air from one or more particular components of computer racks 202. In another embodiment, cooling devices 142 may form a redundant cooling fan array. Such redundant cooling fan array may permit continued cooling of computer racks 202 in the event that one or more of cooling devices 142 fail.

In a further embodiment, cooling device 142 may be a computer room air conditioner unit (CRAC) configured to intake air from a surrounding area through an intake and cool the airflow for output of a cooling airflow with a preconfigured temperature through an exhaust. The output air from cooling device 142 may be directed to computer racks 202, as shown in FIG. 3 by arrows 306 directed at computer racks 202₁ and 202₂. In an embodiment, cooling devices 142 within the array 302 may be arranged in pairs. As shown in FIG. 3, cooling device 142a within cooling device pair 312 may be directed to a portion 308a of computer system 144₁, and cooling device 142b within cooling device pair 312 may be directed to another portion (not shown) of computer system 144₁. Furthermore, at least one cooling device 142 within cooling device pair 310 may be directed to portion 308b of computer system 144₈.

In the same or alternative embodiments, cooling device 142 may be a computer room air handler unit (CRAH) using circulating chilled water and a chiller to cool air emitted from computer racks 202. It is noted that other air handling units, including, but not limited to, in space unit (ISU), hot and cold aisle containment arrangements, and other cooling units, may be used in accordance with the various embodiments described herein.

In the embodiment illustrated in FIG. 3, array 302 may be communicatively coupled to cooling controller 146 (as shown in FIG. 1) to allow cooling controller 146 to control the operation of cooling devices 142. Cooling controller 146 may run in any of various types of computer systems described herein, including desktop computers or workstations, embedded microcontrollers, electronic control units, programmable logic devices, or mainframe computers.

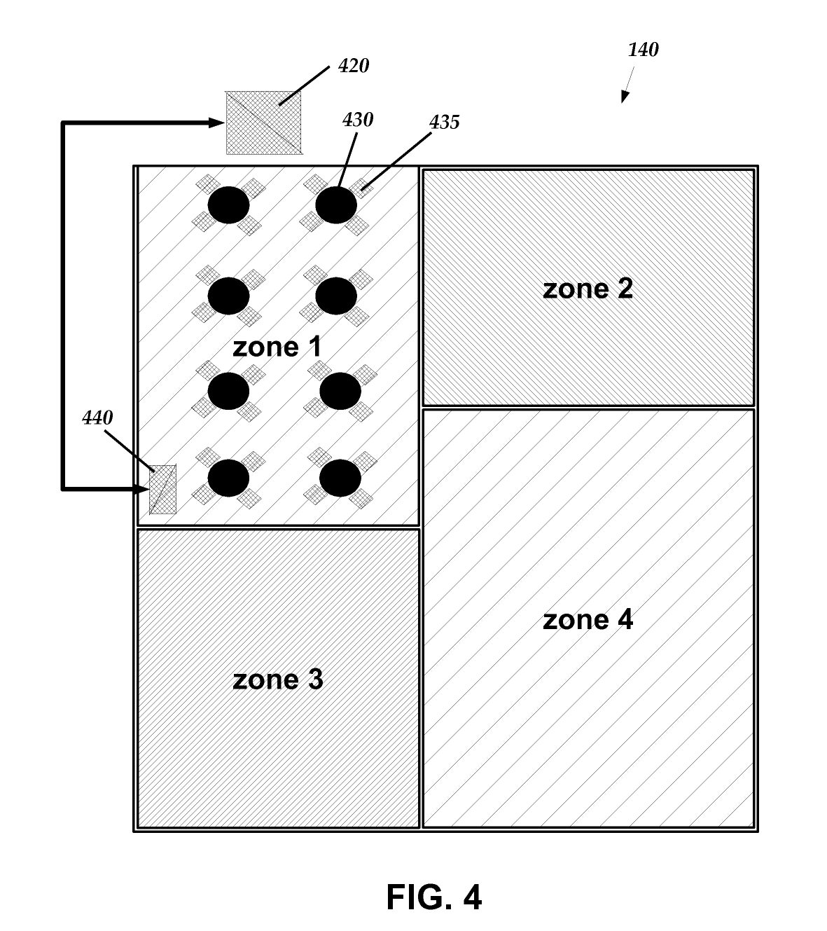

FIG. 4 illustrates various zones in data center 140, according to an embodiment of the invention. Illustratively four zones, zone 1, zone 2, zone 3, and zone 4, have been depicted for the purposes of simplicity. In alternative embodiments, data center 140 may include a different number of zones. Each zone may include one or more monitoring devices. The one or more monitoring devices may monitor and collect data with respect to at least one of heat generation/dissipation patterns, temperature, and data flow patterns. Each of the one or more monitoring devices may monitor computing devices and other data center resources in the vicinity (e.g., within a defined radius of the monitoring device). Furthermore, the one or more monitoring devices may include at least one of a temperature sensor, a camera, an RFID tag, an acoustic sensor, a visual sensor, a semiconducting device, or a thermocouple. As shown in FIG. 4, zone 1 includes monitoring devices 430. A plurality of cooling devices 435 may be associated with and may be located around each of the monitoring devices 430. The arrangement of monitoring devices 430 and the plurality of cooling devices 435 in zone 1 is provided merely as an example. Other arrangements may be made within zone 1 or the other zones of data center 140 without departing from the scope of the various embodiments described herein. The quantity and arrangement of monitoring devices 430, as well as the quantity and arrangement of the plurality of cooling devices 435 with respect to monitoring devices 430, may depend upon the respective locations and characteristics of various components within data center 140.

The plurality of cooling devices 435 each may incorporate at least one of a fan, a CRAC unit, a CRAH unit, ISU, or hot and cold aisle containment arrangements. The plurality of cooling devices 435 may incorporate one or more aspects of cooling devices 142. For instance, the plurality of cooling devices 435 may incorporate an array 302 of cooling devices 142. The plurality of cooling devices 435 may be associated with one or more computer systems 144 hosting respective datasets. The plurality of cooling devices 435 associated with a respective monitoring device 430 may be controlled either via a central control 440 of the zone connected to the monitoring device 430 or directly via a master control 420 that communicates with the monitoring device 430. The central control 440 and the master control 420 may incorporate one or more aspects of cooling controller 146 as previously described with reference to FIG. 1.

With reference to FIG. 4, each of monitoring devices 430 may be connected to a central control 440 associated with zone 1. The central control 440 associated with zone 1 may be connected to master control 420. At least one of central control 440 or master control 420 may be configured to activate the plurality of cooling devices 435. Each of the monitoring devices 430 in zone 1 may communicate with central control 440 and update the central control 440 with real time data regarding at least one of heat generation/dissipation patterns, temperature, or data flow patterns within zone 1. Such real time data may be influenced by datasets hosted on one or more computer systems 144 within zone 1. Central control 440 may receive and collate the real time data and subsequently may transmit the collated data to master control 420. Master control 420 may interface with at least one of internal storage 112 of server computer 106 or storage unit 122, which may store historical data with respect to at least one of dataset access patterns, heat generation/dissipation patterns, and temperature. Furthermore, master control 420 may interface with dataset manager 130 and dataset analyzer 132. Master control 420 may coordinate activities such that operating parameters of the plurality of cooling devices 435 in zone 1 may be dynamically adjusted as a result of analyzing historical parameters of datasets hosted by one or more associated computer systems 144 in zone 1 and monitoring real time data with respect to zone 1.

The other zones of data center 140 may be managed in a similar manner as described above with respect to zone 1, such that heat dissipation and temperature issues may be managed throughout data center 140. In a further embodiment, if a zone within data center 140 does not have a central control 440, then each monitoring device within such zone may communicate directly with master control 420.

In one embodiment, storage unit 122 (e.g., the one or more databases 124) may store a mapping of each dataset in the data center 140 to the zone in which it is located. Such mapping may be utilized to determine which zone(s) are to be monitored with respect to data access patterns, temperature, or heat generation/dissipation patterns. In an alternative embodiment, mapping information may be stored in internal storage 112 of server computer 106. Additionally, storage unit 122 or internal storage 112 may store a mapping of one or more cooling devices (e.g., the plurality of cooling devices 435) to the zone in which they are located. Such mapping may be utilized to identify the one or more cooling devices within one or more zones.

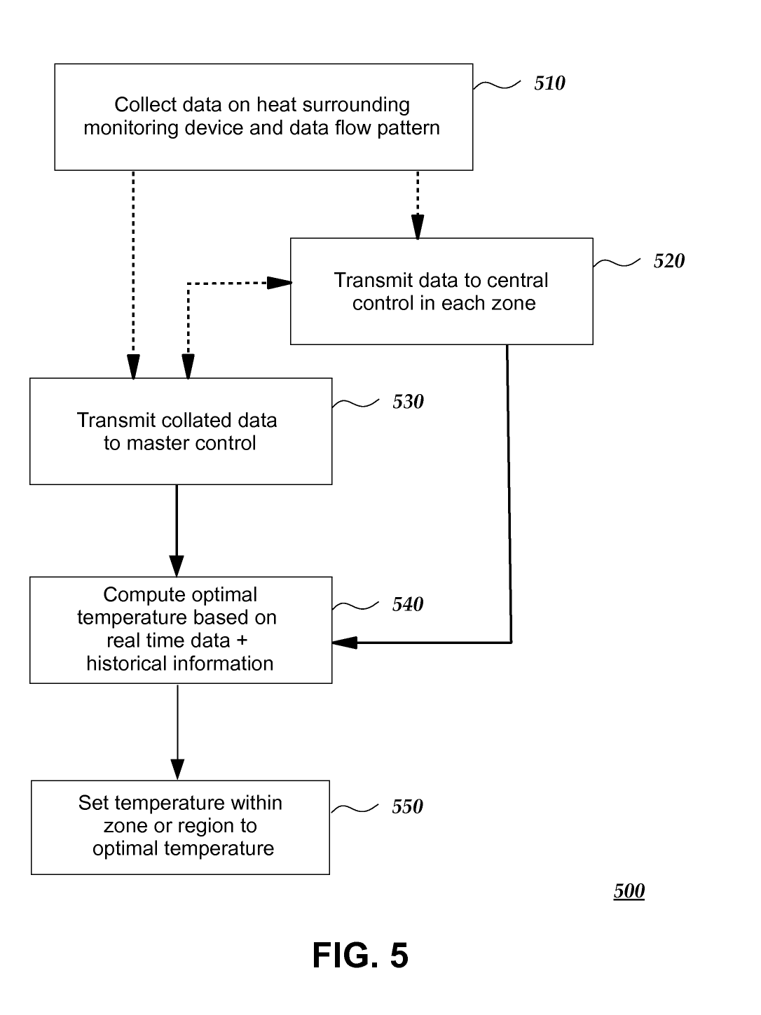

FIG. 5 illustrates a method 500 of monitoring and controlling temperature within one or more regions or zones in a data center (e.g., data center 140). Each of the one or more monitoring devices (e.g., monitoring devices 430) within a zone of the data center may continuously monitor heat generation or temperature in a region surrounding the monitoring device and also may monitor the data flow pattern with respect to the region surrounding the monitoring device. For example, when there is an increase of data flow towards a system located at a monitoring device, based on the data flow patterns and previously recorded data, an optimal cooling temperature may be determined, and one or more cooling devices (e.g., the plurality of cooling devices 435) around the monitoring device may be activated.

The method 500 may begin at step 510, where each of the one or more monitoring devices within a zone may collect data with respect to heat generation or heat dissipation patterns, temperature, or data flow patterns in a region surrounding the monitoring device. In an embodiment, the region surrounding each monitoring device may include an area within a defined radius of the monitoring device. Each monitoring device may monitor a number of computer systems (e.g., computer systems 144) and other resources in the region. At step 520, real time data collected by each of the one or more monitoring devices may be transmitted to a central control (e.g., central control 440) within the zone. Each of the one or more monitoring devices may continuously transmit data regarding heat generation or heat dissipation patterns, temperature, or data flow patterns to the central control within the zone. The central control may collate the data and then may transmit the data to the master control at step 530. In one embodiment, at step 540 the central control may compute an optimal temperature based on both collected real time data and historical data stored in a repository (e.g., historical data with respect to heat generation or heat dissipation patterns, temperature, and/or data flow patterns, which, for instance, may be stored in storage unit 122 or internal storage 112). The optimal temperature may be computed upon determining that there could be an increase in heat generation or temperature due to excessive data flow to one or more computer systems in the vicinity of the one or monitoring devices. At step 550, the central control may set the temperature in the zone or in respective one or more regions surrounding the one or more monitoring devices to the optimal temperature by activating one or more cooling devices around the one or more monitoring devices. In another embodiment, the central control may transmit the data to the master control, and at step 540 the master control may compute the optimal temperature and at step 550 may set the temperature in the zone or in the respective one or more regions surrounding the one or more monitoring devices to the computed optimal temperature by activating the one or more cooling devices around the one or more monitoring devices. In such embodiment, the master control may interface with the central control to activate the one or more cooling devices or alternatively may directly activate the one or more cooling devices. According to an embodiment, the central control or master control may be configured to set the temperature to the computed optimal temperature upon determining that temperature in the zone (e.g., temperature of a region surrounding a monitoring device of the zone or average temperature within the zone) exceeds a predefined threshold.

Alternatively, in one embodiment, at step 530 each of the monitoring devices in the zone may independently transmit the real time data directly to the master control. In such embodiment, there may be no central control present. The master control may receive the data and may be configured to compute at step 540 an optimal temperature based on the real time data collected either for the zone as a whole or for respective one or more regions surrounding the one or more monitoring devices upon determining that there could be an increase in heat generation or temperature due to excessive data flow to one or more computer systems in the vicinity of the one or monitoring devices. The optimal temperature may be computed based on the collected real time data and also based on combining the collected real time data with historical data stored in a repository. Once the optimal temperature is computed for the zone or for the respective one or more regions surrounding the one or more monitoring devices, at step 550 the master control may be configured to set the temperature in the zone or in the respective one or more regions to the computed optimal temperature by activating the one or more cooling devices around the one or more monitoring devices. According to an embodiment, the master control may be configured to set the temperature to the computed optimal temperature upon determining that temperature in the zone (e.g., temperature of a region surrounding a monitoring device of the zone or average temperature within the zone) exceeds the predefined threshold.

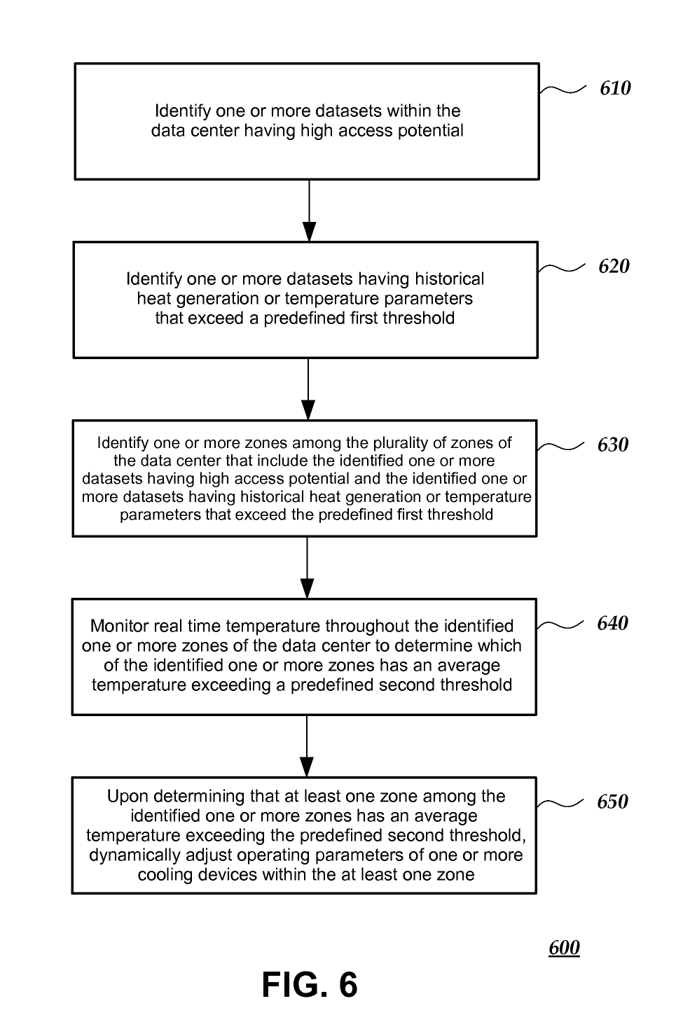

FIG. 6 illustrates a method 600 of monitoring and controlling temperature in a data center (e.g., data center 140). The method 600 may involve dynamically adjusting operating parameters of cooling devices (e.g., the plurality of cooling devices 435) within a data center (e.g., data center 140) having a plurality of zones. The method 600 may begin at step 610, where a master control (e.g., master control 420) may identify one or more datasets within the data center having high access potential. In one embodiment, the master control may identify the one or more datasets having high access potential via predictive heuristic analysis. In an alternative embodiment, the master control may identify the one or more datasets having high access potential via an Information Lifecycle Management (ILM) policy. In using such techniques, the master control may utilize stored dataset access pattern data (e.g., data stored in at least one of internal storage 112 of server computer 106 or storage unit 122 in computer networked environment 100).

At step 620, the master control may identify one or more datasets having historical heat generation or temperature parameters that exceed a predefined first threshold. To identify the one or more datasets with historical heat generation or temperature parameters exceeding the first threshold, the master control may utilize stored dataset temperature and heat generation pattern data (e.g., data stored in at least one of internal storage 112 of server computer 106 or storage unit 122 in computer networked environment 100). Moreover, to identify the one or more datasets with historical heat generation or temperature parameters exceeding the predefined first threshold, the master control may interface with a dataset analyzer with a capability of analyzing heat generation or temperature parameters with respect to datasets of the data center (e.g., dataset analyzer 132).

At step 630, the master control may identify one or more zones among the plurality of zones of the data center that include the identified one or more datasets having high access potential and the identified one or more datasets having historical heat generation or temperature parameters that exceed the predefined first threshold. The master control may utilize stored mapping information to determine the zone in which each of the identified one or more datasets is located.

At step 640, the master control may monitor real time temperature throughout the identified one or more zones of the data center to determine which of the identified one or more zones has an average temperature exceeding a predefined second threshold. In one embodiment, the master control may monitor real time temperature of each zone by receiving collated temperature or heat generation data from a central control associated with the zone (e.g., central control 440). In such embodiment, the central control of the zone may receive the data from one or more monitoring devices (e.g., monitoring devices 430) located within the zone and then may collate the data for transmission to the master control. In an alternative embodiment, the master control may monitor temperature of each zone by receiving temperature or heat generation data directly from the one or more monitoring devices located within the zone. In a further embodiment, the master control may facilitate storage of the real time temperature or heat generation data for future use (e.g., such data may be incorporated into the aforementioned dataset temperature and heat generation pattern data). In a further embodiment, the master control may receive collated data flow pattern data either from the one or more monitoring devices directly or via the central control, and the master control may facilitate storage of such collated data flow pattern data for future use (e.g., such data may be incorporated into the aforementioned dataset access pattern data),

At step 650, upon determining that at least one zone among the identified one or more zones has an average temperature that exceeds the predefined second threshold, the master control may dynamically adjust operating parameters of one or more cooling devices within the at least one zone. In one embodiment, the master control may adjust the operating parameters of the one or more cooling devices by increasing the output of the one or more cooling devices. The master control may increase the output of the one of more cooling devices such that the average temperature within each of the at least one zone is decreased to a predefined amount below the predefined second threshold. In such embodiment, the cooling device settings modified in order to increase output may depend upon characteristics of the one or more cooling devices. The master control may utilize stored mapping information to determine the one or more cooling devices included in the at least one zone.

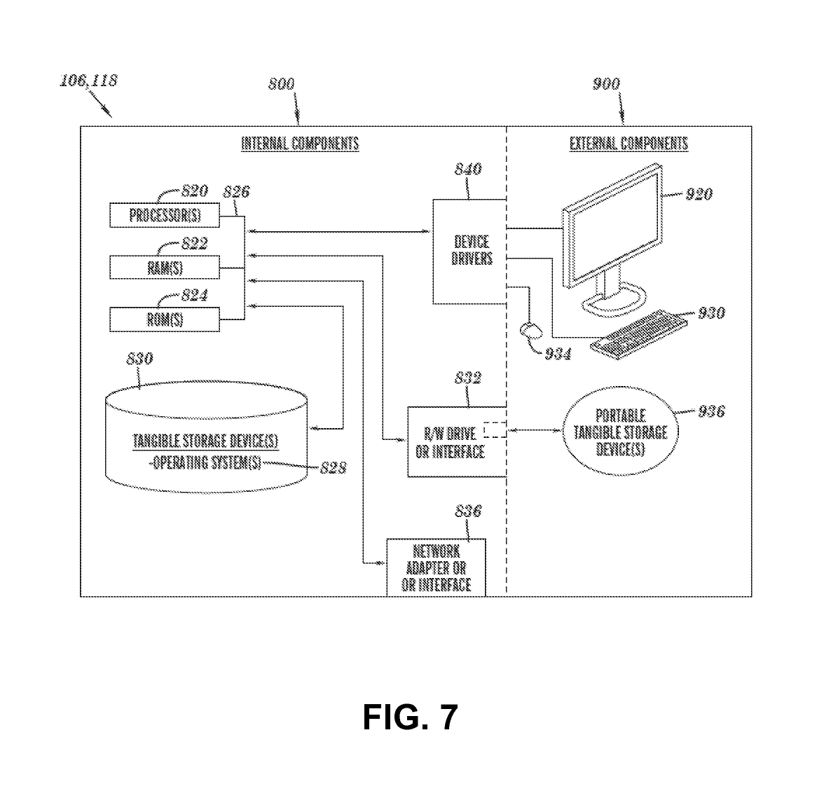

FIG. 7 is a block diagram illustrating internal and external components of the computing devices presented in FIG. 1, according to one embodiment of the invention. Specifically, server computer 106 and client computer 118 each may include respective sets of internal components 800 and external components 900. In a further embodiment, one or more computer systems 144 within each of data centers 104, 105, and 140 may include one or more of internal components 800 and external components 900. Each of the sets of internal components 800 may include one or more processors 820, one or more computer-readable RAMs 822 (which may include cache memory), and one or more computer-readable ROMs 824 on one or more buses 826. Furthermore, each of the sets of internal components 800 may include one or more operating systems 828, which may be stored in one or more computer-readable tangible storage devices 830. At least one of the one or more operating systems 828, dataset manager 130, dataset analyzer 132, or cooling controller 146 may be executed by one or more of processors 820 via one or more of RAMs 822. In one embodiment, each of the computer-readable tangible storage devices 830 may be a magnetic disk storage device of an internal hard drive. In an alternative embodiment, each of the computer-readable tangible storage devices 830 may be a semiconductor storage device such as ROM, EPROM, flash memory, or any other computer-readable tangible storage device that can store a computer program and digital information.

Each of the sets of internal components 800 also may include a R/W drive or interface 832 to read from or write to one or more portable computer-readable tangible storage devices 936, such as a CD-ROM, DVD, memory stick, magnetic tape, magnetic disk, optical disk, or semiconductor storage device. One or more aspects of dataset manager 130, dataset analyzer 132, and cooling controller 146 may be stored on one or more of portable computer-readable tangible storage devices 936, may be read via R/W drive or interface 832, and may be loaded into one or more computer-readable tangible storage devices 830.

Each of the sets of internal components 800 also may include a network adapter or interface 836, such as a TCP/IP adapter card. One or more aspects of dataset manager 130 and dataset analyzer 132 may be downloaded to sever computer 106 from an external computer via a network (e.g., network 102) and network adapter or interface 836. Via the network adapter or interface 836, one or more aspects of dataset manager 130 and dataset analyzer 132 may be loaded into one or more computer-readable tangible storage devices 830.

Each of the sets of external components 900 may include a computer display monitor 920, a keyboard 930, and a computer mouse 934, and the aforementioned portable computer-readable tangible storage devices 936. Each of the sets of internal components 800 may include device drivers 840 configured for interfacing with computer display monitor 920, keyboard 930, and computer mouse 934. Device drivers 840, R/W drive or interface 832, and network adapter or interface 836 may include both hardware aspects and software aspects; the software aspects may be stored in the one or more computer-readable tangible storage devices 830 and/or the one or more ROMs 824).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein has been chosen to best explain the principles of the embodiments, the practical application or technical improvement over technologies found in the marketplace, or to enable others of ordinary skill in the art to understand the embodiments disclosed herein.

What is claimed is:

1. A method of monitoring and controlling temperature in a data center, the data center including a plurality of zones, the method comprising:
receiving real time data from one or more monitoring devices in a zone among the plurality of zones at a central control located within the zone, wherein the real time data includes temperature and data flow patterns, and wherein the central control includes one or more processors;
collating the real time data from each of the one or more monitoring devices at the central control; and
upon determining that the temperature in the zone exceeds a predefined threshold, activating one or more cooling components in the zone, thereby maintaining the temperature in the zone at an optimal temperature.

2. The method of claim 1, further comprising transmitting the collated real time data from the central control to a master control subsequent to collating the data in real time.

3. The method of claim 1, wherein at least one of the central control or the master control determines from the real time data whether the temperature in the zone exceeds the predefined threshold.

4. The method of claim 1, wherein at least one of the central control or the master control computes the optimal temperature based on the real time data and historical data stored in a repository.

5. The method of claim 1, wherein the one or more monitoring devices include at least one of a temperature sensor, a camera, an RFID tag, an acoustic sensor, a visual sensor, a semiconducting device, or a thermocouple.

6. The method of claim 1, wherein the real time data further includes heat generation patterns.

7. The method of claim 1, wherein the temperature and the data flow pattern are monitored in real time and collated in real time for the zone.

8. The method of claim 1, wherein at least one of the central control or the master control activates the one or more cooling components in the zone.

9. The method of claim 1, wherein at least one of the central control or the master control is configured to activate one or more cooling components in a region surrounding a monitoring device among the one or more monitoring devices.

10. The method of claim 2, wherein the central control or the master control includes at least one of an integrated circuit processor or a computing system.

11. A method of monitoring and controlling temperature in a data center, the data center including a plurality of zones, the method comprising:
receiving real time data from one or more monitoring devices in a zone among the plurality of zones at a master control, wherein the real time data includes temperature and data flow patterns, and wherein the master control includes one or more processors;
determining from the real time data whether the temperature in a region surrounding a monitoring device among the one or more monitoring devices exceeds a predefined threshold; and
upon determining that the temperature in the region surrounding the monitoring device exceeds the predefined threshold, activating one or more cooling components in the region surrounding the monitoring device, thereby maintaining the temperature in the region surrounding the monitoring device at an optimal temperature.

12. The method of claim 11, wherein the master control collates the real time data received from each of the one or more monitoring devices at the master control.

13. The method of claim 11, wherein the master control computes the optimal temperature based on the real time data received from at least one of the one or more monitoring devices and historical data stored in a repository.

14. The method of claim 11, wherein the one or more monitoring devices include at least one of a temperature sensor, a camera, an RFID tag, an acoustic sensor, a visual sensor, a semiconducting device, or a thermocouple.

15. The method of claim 11, wherein the real time data further includes heat generation patterns.

16. The method of claim 11, wherein the master control activates one or more cooling components in the zone.

17. The method of claim 11, wherein the master control activates the one or more cooling components in the region surrounding the monitoring device.

18. The method of claim 11, wherein the master control includes at least one of an integrated circuit processor or a computing system.

19. A device comprising at least one processor, wherein the at least one processor is configured to:
receive real time data from one or more monitoring devices in a zone among the plurality of zones of a data center, wherein the real time data includes temperature and data flow patterns;
determine from the real time data whether the temperature in a region surrounding a monitoring device among the one or more monitoring devices exceeds a predefined threshold; and
upon determining that the temperature in the region surrounding the monitoring device exceeds the predefined threshold, activate one or more cooling components in the region surrounding the monitoring device, thereby maintaining the temperature in the region surrounding the monitoring device at an optimal temperature.

20. The device of claim 19, wherein the at least one processor is configured to compute the optimal temperature based on the real time data received from the one or more monitoring devices and historical data stored in a repository.
